(19) United States
(12) Patent Application Publication
(10) Pub. No.: US 2008/0248348 A1
(43) Pub. Date: Oct. 9, 2008

(54) Fuel-Cell Installation, Method For Activating and Deactivating Said Installation

(75) Inventors: Peter Britz, Egmating (DE); Klaus Heikrodt, Allendorf (DE); Dieter Melzner, Goettingen (DE); Annette Reiche, Goettingen (DE)

Correspondence Address: THE WEBB LAW FIRM, P.C., 700 KOPPERS BUILDING, 436 SEVENTH AVENUE, PITTSBURGH, PA, 15219, US

(73) Assignees: VIESSMANN WERKE GMBH & CO., KG, ALLENDORF (DE); SARTPROIS AG, GOETTINGEN (DE)

(21) Appl. No.: 10/592,979

(22) PCT Filed: Mar. 16, 2005
(86) PCT No.: PCT/DE2005/000189

§ 371 Date: Oct. 31, 2007

(30) Foreign Application Priority Data
Mar. 17, 2004 (DE) 10 2004 013 337.9

(51) Int. Cl. H01M 8/06; H01M 8/10; H01M 8/04

(52) U.S. Cl. 429/20; 429/30; 429/24; 429/17

(57) ABSTRACT

The invention relates to a fuel-cell installation comprising: a reformer stage, which can be heated by a gas burner in order to carry out the water-vapour reformation of hydrocarbon and water-vapour into hydrogen and additional reformer products; at least one conversion stage, which is connected downstream of the reformer stage for the chemical preparation of the reformer products; and at least one fuel-cell stack, which is connected downstream of the conversion stage and comprises a plurality of anodes and cathodes with corresponding supply and discharge connections for converting the hydrogen into water to generate an electric current and heat. The fuel-cell stack is configured as a high-temperature fuel-cell stack with an operating temperature between about 100° C. and about 200° C., the conversion stage is connected on the output side, without heat exchange, to the supply connection of the anode of the fuel-cell stack and the discharge connection of the anode of the fuel-cell stack is connected to an air supply connection on the gas burner. During the activation and/or deactivation of the fuel-cell installation, the air that has flowed through the reformer stage and the conversion stage can be selectively supplied to the anode of the fuel cell stack.

The invention relates to a fuel cell installation according to the preamble of patent Claim 1, a method for starting this installation according to the preamble of patent Claim 5 and the method for shutting down this installation according to the preamble of patent Claim 7.

A fuel cell installation of the type defined in the preamble is known from DE 101 60 463 A1. It consists of a reformer stage for steam reforming of hydrocarbons and/or hydrocarbon gas (especially natural gas) and steam into hydrogen and other reformer products such as carbon dioxide and carbon monoxide. The reformer stage is therefore heatable with a gas burner. For chemical processing of reformer products, i.e., for converting the carbon monoxide into carbon dioxide in particular (carbon monoxide is a so-called fuel cell poison), at least one shift stage is connected downstream from the reformer stage. Depending on the required degree of purity of the reformer products, two or more gas purification stages may also be provided, e.g., a so-called fine gas refining stage and a methanization stage or a stage for selective oxidation (selox stage). Downstream from the at least one shift stage, there is at least one fuel cell stack having a plurality of anodes and cathodes with corresponding inlet and outlet connections for converting the hydrogen into water for generating electricity and heat. German Patent DE 101 60 463 A1 describes a so-called PEM fuel cell stack which is operated at a temperature of approximately 70° C. Since the hydrogen and the other reformer products produced in the reformer apparatus leave the last gas purification stage at approximately 120° C., a heat exchanger is provided between the last gas purification stage and the fuel cell stack to ensure the required drop in temperature. At the same time, however, this heat exchanger is also designed as a condensate separator to have the least possible negative effect on the relatively sensitive water balance of the fuel cell while on the other hand being able to supply the quantities of water thereby generated back to the overall process.

German Patent DE 101 32 064 A1 also describes a method for operating an apparatus for generating hydrogen, whereby only air preheated by a burner is supplied to the reformer through an inlet connection at least for a certain phase for starting the apparatus until the reformer and the at least one downstream shift stage have reached the operating temperature. Since the function of the fuel cell depends greatly on the moisture content of the membrane and this is necessarily sensitive to air on the anode end, in startup of the installation a corresponding multiple-way valve must be provided after the last shift stage (usually the fine gas refining stage) to be able to suppress an air supply to the anodes of the fuel cell.

Although this measure is just as easy to implement constructively as the heat exchanger and the condensate separator connected downstream from the last shift stage according to German Patent DE 101 60 463 A1, nevertheless the jump in temperature which necessarily occurs (e.g., at the end of the startup process due to the addition of the reformate flow to the fuel cell) between the reformer apparatus and the fuel cell also tends to be unfavorable with regard to the overall efficiency of the installation.

Accordingly, the object of the present invention is to improve upon a fuel cell installation of the type defined in the preamble such that it is possible to omit the temperature reduction and condensate separation between the shift stage and the fuel cell stack. Another object of the present invention is to simplify the startup phase of the installation as described above according to German Patent DE 101 32 064 A1 and to also simplify shutting down the installation by means of an air supply both through the design and the process.

These objects are achieved constructively with a fuel cell installation of the type defined in the preamble by the features characterized in the characterizing part of patent Claim 1. In terms of the process, the characterizing features of patent Claims 5 and 7 solve these tasks.

Thus, according to this invention, the fuel cell stack is designed as a high-temperature fuel cell stack having an operating temperature between 100° C. and 200° C.; the shift stage is connected at the outlet end to the inlet connection of the anodes of the fuel cell stack without an intervening heat exchanger, and the outlet connection of the anodes of the fuel cell stack is connected to an air inlet connection on the gas burner.

A suitable high-temperature fuel cell stack is known from German Patent DE 101 55 543 C2, for example. The content of that publication is herewith also incorporated into the present patent application. The stack described there is in principle a so-called polymer electrolyte membrane fuel cell (PEM fuel cell) but with the difference that the operating temperature is not approximately 70° C. but instead is between 100° C. and 200° C. Only the use of this stack makes it possible to connect the outlet of the shift stage hydraulically directly to the anode inlet of the fuel cell, because, firstly, due to the elevated operating temperature of the stack, no reduction in temperature between the reformer apparatus and the fuel cell is necessary, and secondly, no liquid water which would clog the membranes of the fuel cell and would thus degrade the stack is produced at this operating temperature.

For the sake of thoroughness, reference is also made to German Patent DE 102 09 681 A1, wherein a fuel cell installation according to the preamble of patent Claim 1 is disclosed. With this installation, however, the exhaust gas of this shift stage is not sent to the fuel cell until reaching an optimum gas quality. This requires a directional valve arranged between the shift stage and the fuel cell, and this valve must be operated via a sensor and a corresponding circuit. This constellation is thus much more complicated and also does not have the advantages listed below. The same thing is also true of German Patent DE 102 35 430 A1.

In terms of the process, for starting an inventive fuel cell installation, in a first startup step, preheated air is passed through the reformer stage, through the shift stage and, at the anode end, through the fuel cell stack, whereby the air flowing through the fuel cell stack at the anode end is supplied to the gas burner provided for heating the reformer stage, and in a second startup step, the air supply is turned off and at least the steam supply and optionally also the hydrocarbon gas supply are turned on.

In terms of the process, for shutting down an inventive fuel cell installation, the hydrocarbon gas supply and the steam supply are shut down in a first shutdown step and in a second shutdown step, the air supply is turned on and the air is passed through the reformer stage, through the shift stage and, at the anode end, through the fuel cell stack, whereby the air flowing through the fuel cell stack at the anode end is sent to the gas burner provided for heating the reformer stage.

These measures can also be implemented only on the basis of the inventive use of a high-temperature fuel cell, in particular the fuel cell according to German Patent DE 101 55 543 C2, because only if the fuel cell is insensitive to air on the anode end when starting the reformer can the air be used, on the one hand, not just for heating the reformer and the shift stage(s) but also for heating the stack and on the other hand for gradual cooling of all the aforementioned components when shutting down the fuel cell installation, which advantageously even leads to drying out of the components at the anode end.

Other advantageous refinements are derived from the dependent patent claims.

On the basis of the drawing of a preferred exemplary embodiment, the inventive fuel cell installation and its advantageous refinements according to the dependent patent claims are explained in greater detail below with regard to their design features and also with regard to their operation.

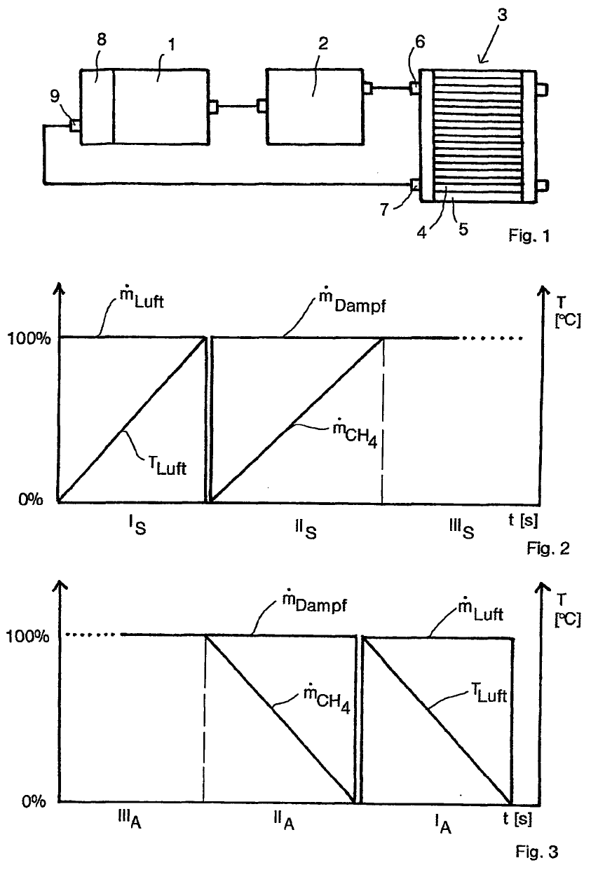

FIG. 1 shows schematically the inventive fuel cell installation;

FIG. 2 shows a diagram of the inventive startup process of the fuel cell installation; and

FIG. 3 shows a diagram of the inventive shutdown process for the fuel cell installation.

FIG. 1 shows schematically first a preferred embodiment of the inventive fuel cell installation which consists of a reformer stage 1 for steam reforming hydrocarbons (preferably hydrocarbon gas) and steam to yield hydrogen and other reformer products. In an essentially known manner, a gas burner 8 is provided for the reformer stage 1 to supply the heat required for the reforming process, i.e., the reformer stage 1 can be heated with the gas burner 8. In the case of an installation for supplying household power, which is the preferred usage in the present case, natural gas (methane gas) is supplied to both the burner 8 and the reformer stage 1 in steady-state operation, this gas being supplied as the hydrocarbon gas, preferably obtained from a gas tap provided in-house. The heat of the gas burner 8 may also be output for other heating purposes (household heating).

Since carbon monoxide is also usually produced in steam reforming in addition to hydrogen and carbon dioxide, at least one shift stage 2 is connected downstream from the reformer stage 1, likewise in an essentially known manner, for chemical processing of the reformer products, i.e., in particular for reducing the carbon monoxide content. Depending on the required level of purity with regard to the carbon monoxide content, installations having two or more shift stages (including fine gas purification stage such as a methanization stage or a selox stage) are also known (as also mentioned above).

The at least one fuel cell stack 3 having a plurality of anodes 4 and cathodes 5 with corresponding inlet and outlet connections 6, 7 is connected downstream from the at least one shift stage 2 for converting hydrogen to water for generating electricity and heat, whereby the stack, as mentioned above, is designed as a so-called polymer electrolyte membrane fuel cell (PEM fuel cell).

Since the gas outlet temperature after the last shift stage 2 is always more than 100° C. with the known fuel cell installation, a heat exchanger, frequently also a condensate separator, is usually arranged between the last shift stage 2 or fine gas purification stage and the fuel cell stack 3.

To reduce this design complexity, it is provided according to the present invention that the fuel cell stack 3 is designed as a high-temperature fuel cell stack with an operating temperature between 100° C. and 200° C., preferably 160° C. In this regard, proton-conducting high-temperature electrolyte membranes are also provided for use in the stack. These include in the sense of DE 101 55 543 C2 at least one basic material and at least one dopant, whereby the dopant is a reaction product of one at least dibasic inorganic acid with an organic compound, whereby the reaction product has an unreacted acidic hydroxyl group of the inorganic acid or is the condensation product of this compound with a polybasic acid. These high-temperature electrolyte membranes are suitable for operation at these temperatures, which are relatively high for PEM fuel cells.

In addition, according to this invention, the shift stage 2 is directly connected at the output end (as shown clearly in FIG. 1) hydraulically and without a heat exchanger to the inlet connection 6 of the anodes 4 of the fuel cell stack 3, i.e., according to this invention, preferably only a short segment of pipe (and in particular no heat exchanger) is provided between the shift stage 2 and the fuel cell stack to hydraulically connect the two installation components to one another.

As shown clearly in FIG. 1, it is also provided that the outlet connection 7 of the anodes 4 of the fuel cell stack 3 is connected to an air inlet connection 9 on the gas burner 8. According to this provision, residual anode gas can be burned in the gas burner 8 during steady-state operation, but on the other hand, during the startup phase (to be explained in greater detail below), preheated air flowing through the stack on the anode end is supplied to the gas burner 8, i.e., the air preheated for starting may be reused energetically in an appropriate manner and is not simply released to the environment. To adjust the correct combustion values, a corresponding lambda probe is provided on the gas burner 9 in a known manner.

For starting and/or shutting down the fuel cell installation, it is provided in an essentially known way that the reformer stage 1 and the shift stage 2 are supplied exclusively with air during at least some phases.

According to this invention, on the basis of the design features described above (high-temperature fuel cell, connection between the shift stage and the stack without a heat exchanger) it is provided that optionally in starting up and/or shutting down the fuel cell installation, the air flowing through the reformer stage 1 and the shift stage 2 is also supplied to the anodes 4 of the fuel cell stack 3. This has the advantage (in startup) that, first, no reversing valve need be provided between the shift stage 2 and the fuel cell stack 3, and the air preheated by the gas burner 8 may also be used for preheating the fuel cell stack 3 while on the other hand (in shutting down the installation) the fuel cell stack 3 can in principle be run dry on the anode end owing to the measure according to this invention, which advantageously leads to precisely defined startup conditions in the event of a restart.

FIG. 2 shows a preferred starting phase and FIG. 3 shows a preferred shutdown phase. The left ordinate in each case shows the percentage amount of process gases and the right ordinate shows the temperature of the air which is supplied in phases. Time is plotted on the abscissa.

As shown in FIG. 2, for starting the fuel cell installation in a first startup step Iₛ preheated air \dot{m}_{Air} is passed through the reformer stage 1, through the shift stage 2 and at the anode end through the fuel cell stack 3. In addition, there are advantageously provisions for the temperature T_{Air} of the air used to start the fuel cell installation to increase with an increase in length of the first startup step, i.e., preheating of the installation is continued until the air is cut off. Heating of the air is accomplished via the gas burner 8.

Next, it is advantageously provided that in a second startup step II_{S} the air supply is turned off and at least the steam supply \dot{m}_{Steam} and optionally also the hydrocarbon gas supply \dot{m}_{CH4} are turned on. According to FIG. 2, the hydrocarbon gas supply \dot{m}_{CH4} increases linearly up to the start of the third steady-state phase III_{S}. In the third phase III_{S} the quantity of hydrocarbon gas and steam supplied each amounts to 100% and no further air is supplied (not even possible because of the imminent danger of an explosive reaction).

As shown in FIG. 3, to shut down the fuel cell installation running in a steady state (operating phase III_{A}=III_{S}) in a first shutdown step II_{A} the hydrocarbon gas supply \dot{m}_{CH4} and the steam supply \dot{m}_{Steam} are shut down and specifically the hydrocarbon gas is preferably tapered off and then the steam is shut down suddenly.

In addition, there are advantageously provisions for the air supply \dot{m}_{Air} to be turned on in a second shutdown step I_{A} and for the air to be passed through the reformer stage 1, through the shift stage 2 and, at the anode end, through the fuel cell stack 3. As FIG. 3 shows, the temperature T_{Air} of the air used for shutdown of the fuel cell installation then declines with an increase in length of the second shutdown step I_{A} (because of the deliberately throttled heat output of the gas burner 8).

As mentioned above and as depicted in FIG. 1 there are also advantageously provisions for the air flowing through the fuel cell stack 3 in startup and/or shutdown at the anode end to be supplied to the gas burner 8 provided for heating the reformer stage 1.

Finally, there are advantageously provisions (not depicted here) for providing a temperature-regulating device which shuts down the fuel cell stack 3 at an operating temperature above 200° C. to ensure that operating temperature of 100° C. to 200° C. is maintained.

### LIST OF REFERENCE NUMERALS

1 reformer stage
2 shift stage
3 fuel cell stack
4 anode
5 cathode
6 inlet connection
7 outlet connection
8 gas burner
9 air inlet connection
I_{S} first startup step
II_{S} second startup step
III_{S} steady-state operating phase
III_{A} steady-state operating phase
II_{A} first shutdown step
I_{A} second shutdown step

1-8. (canceled)

9. A fuel cell installation, comprising
a reformer stage heatable with a gas burner for steam reforming of hydrocarbons and steam into hydrogen and at least one further reformer product,
at least one shift stage downstream from the reformer stage for chemical processing of the at least one further reformer product and
at least one fuel cell stack having a plurality of anodes and cathodes with corresponding inlet and outlet connections downstream from the shift stage for converting the hydrogen into water for generating electricity and heat, wherein
the fuel cell stack is a high-temperature fuel cell stack having an operating temperature between about 100° C. and about 200° C.,
the shift stage is connected at an outlet end to the inlet connection of the anodes of the fuel cell stack without a heat exchanger, and
the outlet connection of the anodes of the fuel cell stack is connected to an air inlet connection on the gas burner.

10. The fuel cell installation according to claim 9, wherein the fuel cell stack is provided with proton-conducting high-temperature electrolyte membranes.

11. The fuel cell installation according to claim 10, wherein the high-temperature electrolyte membranes comprise at least one basic material and at least one dopant, further wherein the dopant is a reaction product of an at least dibasic inorganic acid with an organic compound, and the reaction product has an unreacted acidic hydroxyl group of the inorganic acid or the condensation product of this compound with a polybasic acid.

12. The fuel cell installation according to claim 9, wherein a temperature regulating device is provided to ensure the operating temperature of about 100° C. to about 200° C., the temperature regulating device configured to shut down the fuel cell stack at an operating temperature above about 200° C.

13. A method for starting the fuel cell installation of claim 9, the method comprising the steps of:
in a first startup step, passing preheated air through the reformer stage, through the shift stage and, on an anode end, through the fuel cell stack, whereby air flowing through the fuel cell stack on the anode end is supplied to the gas burner which is provided for heating the reformer stage; and
in a second startup step, turning off the air supply and turning on at least a steam supply,
wherein air is exclusively supplied to the reformer stage and the shift stage when starting up the fuel cell installation.

14. The method according to claim 13, wherein the temperature of the air used to start the fuel cell installation increases with an increase in a length of the first startup step.

15. A method for shutting down the fuel cell installation of claim 9, the method comprising the steps of:
in a first shutdown step shutting down a hydrocarbon gas supply and a steam supply; and
in a second shutdown step, turning on an air supply such that air is sent through the reformer stage, through the shift stage and, on an anode end, through the fuel cell stack, whereby air flowing through the fuel cell stack on the anode end is sent to the gas burner which is provided for heating the reformer stage,
wherein air is exclusively supplied to the reformer stage and the shift stage during startup and shutdown of the fuel cell installation.

16. The method according to claim 15, wherein the temperature of the air used to shut down the fuel cell installation decreases with an increase in length of the second shutdown step.

17. The method of claim 13, wherein the second startup step further comprises turning on a hydrocarbon gas supply.
